(19) United States
(12) Patent Application Publication
(10) Pub. No.: US 2024/0326076 A1
(43) Pub. Date: Oct. 3, 2024

(54) AGRICULTURAL SYSTEM AND METHOD FOR MONITORING SPRAY BOOMS OF AN AGRICULTURAL APPLICATOR

(71) Applicant: CNH Industrial America LLC, New Holland, PA (US)

(72) Inventor: Kevin M. Smith, Narvon, PA (US)

(21) Appl. No.: 18/127,348

(22) Filed: Mar. 28, 2023

(51) Int. Cl. B05B 12/08; A01M 7/00; B05B 1/20

(52) U.S. Cl. CPC B05B 12/08; A01M 7/0057; A01M 7/0071; A01M 7/0089; B05B 1/20; A01C 23/047

(57) ABSTRACT

An agricultural system for monitoring spray booms of an agricultural applicator includes a boom assembly having a wing frame section pivotably coupled to a central frame section, with the wing frame section extending along a length. Further, the agricultural system includes a sensor having a field of view directed along a portion of the length of the wing frame section and configured to generate data indicative of a pitch of the wing frame section along the portion of the length of the wing frame section. Additionally, the agricultural system includes a computing system configured to receive the data, determine variation in the pitch of the wing frame section along the portion of the length of the wing frame section based at least in part on the data, and control an operation associated with the agricultural applicator based at least in part on the variation in the pitch.

### FIELD OF THE INVENTION

The present disclosure relates generally to agricultural applicators, such as agricultural sprayers and, more particularly, to systems and methods for monitoring a boom assembly during an application operation and controlling various operations of the boom assembly based on the data generated while monitoring the boom assembly.

### BACKGROUND OF THE INVENTION

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients, such as a pesticide(s) (e.g., an herbicide(s), insecticide(s), rodenticide(s), etc.) and/or a nutrient(s).

The applicators may be self-propelled or pulled as an implement, and can include a tank, a pump, a boom assembly, and one or more nozzle assemblies carried by the boom assembly at spaced apart locations. The boom assembly can include a pair of boom arms, with each boom arm extending to either side of the applicator when in an unfolded state. Each boom arm may include multiple boom segments, with each boom segment capable of being associated with a number of the nozzle assemblies. Each nozzle assembly typically includes a spray nozzle and an associated nozzle valve to regulate the output of the spray nozzle. With such configurations, the product pump is configured to supply an agricultural product from the tank through a pump line to individual boom arm lines coupled in parallel to the pump line, with each boom arm line being coupled in parallel to the respective spray nozzles of such boom segment to allow the agricultural product to be supplied to each spray nozzle. During an application operation, however, various factors may affect a quality of application of the agricultural product to the field. For instance, boom arm movement of the boom assembly while the vehicle moves along the field may lead to inconsistent application of the agricultural product.

Accordingly, an improved system and method for monitoring the quality of application of the agricultural product to the field by monitoring movement of the boom assembly would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for monitoring spray booms of an agricultural applicator. The agricultural system may include a boom assembly of an agricultural applicator, where the boom assembly has a central frame section and a wing frame section pivotably coupled to the central frame section, with the wing frame section extending along a length defined between a first end and a second end. Further, the agricultural system may include a plurality of nozzle assemblies spaced apart along the boom assembly. Moreover, the agricultural system may include a sensor having a field of view directed along a portion of the length of the wing frame section, with the sensor being configured to generate data indicative of a pitch of the wing frame section along the portion of the length of the wing frame section. Additionally, the agricultural system may include a computing system communicatively coupled to the sensor. Particularly the computing system may be configured to receive the data generated by the sensor, determine variation in the pitch of the wing frame section along the portion of the length of the wing frame section based at least in part on the data, and control an operation associated with the agricultural applicator based at least in part on the variation in the pitch of the wing frame section.

In another aspect, the present subject matter is directed to an agricultural method for monitoring spray booms of an agricultural applicator, where the agricultural applicator has a boom assembly which may include a central frame section and a wing frame section pivotably coupled to the central frame section, with the wing frame section extending along a length defined between a first end and a second end, and with the agricultural applicator further having a plurality of nozzle assemblies spaced apart along the boom assembly. The agricultural method may include receiving, with a computing system, data generated by a sensor having a field of view directed along a portion of the length of the wing frame section, where the data may be indicative of a pitch of the wing frame section along the portion of the length of the wing frame section. The agricultural method may further include determining, with the computing system, a variation in the pitch of the wing frame section along the portion of the length of the wing frame section based at least in part on the data. Additionally, the agricultural method may include controlling, with the computing system, an operation associated with the agricultural applicator based at least in part on the variation in the pitch of the wing frame section.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural applicator in accordance with aspects of the present subject matter;

FIG. 2 illustrates a side view of the applicator shown in FIG. 1 in accordance with aspects of the present subject matter, particularly illustrating the applicator in a transport position:

FIG. 3 illustrates a simplified, schematic top-down view of some embodiments of a boom arm of a boom assembly in accordance with aspects of the present subject matter, particularly illustrating the boom arm in an expected position, a forward deflected position, and a rearward deflected position:

FIGS. 4A-4C illustrate simplified, schematic top-down views of some embodiments of a boom arm of a boom assembly in accordance with aspects of the present subject matter, particularly illustrating the boom arm having varying pitch while deflecting in a forward and a rearward direction from a default position:

FIGS. 5A-5C illustrate simplified, schematic rear views of some embodiments of a boom arm of a boom assembly in accordance with aspects of the present subject matter, particularly illustrating the boom arm having varying pitch while deflecting in a forward and a rearward direction from a default position:

FIG. 6 illustrates a simplified, schematic section view of part of a boom arm of a boom assembly in accordance with aspects of the present subject matter taken with reference to section line 6-6′ across FIGS. 4A-4C, particularly illustrating an outer nozzle assembly having varying spray angles while the boom arm deflects in a forward and a rearward direction from a default position:

FIG. 7 illustrates a schematic view of a system for monitoring spray booms of an agricultural applicator in accordance with aspects of the present subject matter; and

FIG. 8 illustrates a flow diagram of one embodiment of a method for monitoring spray booms of an agricultural applicator in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for monitoring spray booms of an agricultural applicator. Specifically, in several embodiments, the disclosed systems may monitor pitch of the spray booms of an agricultural applicator as the applicator performs an application operation, and control various operations of the agricultural applicator based on the monitored pitch. For instance, an agricultural applicator or “sprayer” may include a boom assembly having a central frame section and a wing frame section pivotably coupled to the central frame section, where the wing frame section extends along a length defined between a first end and a second end, and where nozzle assemblies are generally spaced apart along the boom assembly. In several embodiments, the wing frame section is pivotable by an actuator between a working position for performing an application operation, where the wing frame section extends generally laterally outwardly from the central frame section, and a folded or transport position for traveling.

During an application operation, various forces may cause the wing frame section to pivot relative to the central frame section, such as in a fore-aft direction. For instance, if the applicator experiences a sudden change in speed (e.g., sudden starting, hard braking, etc.), hits an obstacle, encounters a change in terrain (e.g., hill, bump, etc.), and/or the like, the wing frame section may swing relative to the central frame section in the fore-aft direction. Depending on the configuration of the wing frame sections and the speed with which the wing frame sections swing fore or aft, the wing frame sections may also twist or pitch. Generally, the greater the length of the wing frame sections, the greater the potential twisting or pitching of the wing frame sections. A magnitude of the pitching caused by the fore-aft pivoting varies along the length of the wing frame sections. For instance, an outermost portion of the wing frame sections may be pitched more than inner portions of the wing frame sections such that, for example, the outermost nozzle assemblies pitch more than second outermost nozzle assemblies, which pitch more than third outermost nozzle assemblies, and so forth.

Fore-aft movement causes the nozzle assemblies on the fore-aft deflected portions of the wing frame sections to be offset from an assumed position, which can lead to imprecise or misapplication of agricultural product as many application operations use application routines based on an assumed or default position of the nozzle assemblies. The addition of pitch further causes the nozzle assemblies on the pitched portions of the wing frame sections to be offset in position from an assumed position, which can further lead to imprecise or misapplication of agricultural product when application operations use application routines based on an assumed or default position of the nozzle assemblies. It may be difficult to account for the fore-aft deflection, let alone variation in the pitch along the wing frame sections during such fore-aft deflection.

Thus, in accordance with aspects of the present subject matter, a sensor (e.g., a camera, a LIDAR sensor, and/or the like) is provided in operative association with the spray boom. The sensor may generally have a field of view directed along a portion of the length of at least one of the wing frame sections and be configured to generate data indicative of at least a pitch of the wing frame section along the portion of the length of the wing frame section. A computing system communicatively coupled to the sensor may be configured to receive the data generated by the sensor and determine the pitch, specifically a variation of the pitch, of the wing frame section along the portion of the length of the wing frame section based at least in part on the data. The computing system may further be configured to automatically control an operation associated with the agricultural applicator based at least in part on the variation in the pitch of the wing frame section. For instance, the computing system may be configured to automatically control an operation of a user interface to indicate the variation in pitch and/or a recommended change in driving style (e.g., change speeds more gradually, avoid bumps, etc.), automatically control an operation of one or more actuators of the applicator (e.g., an actuator of the wing frame section), automatically adjust a ground speed of the agricultural applicator, automatically adjust an operation of one or more of the nozzle assemblies based at least in part on the variation in the pitch of the wing frame section, and/or the like.

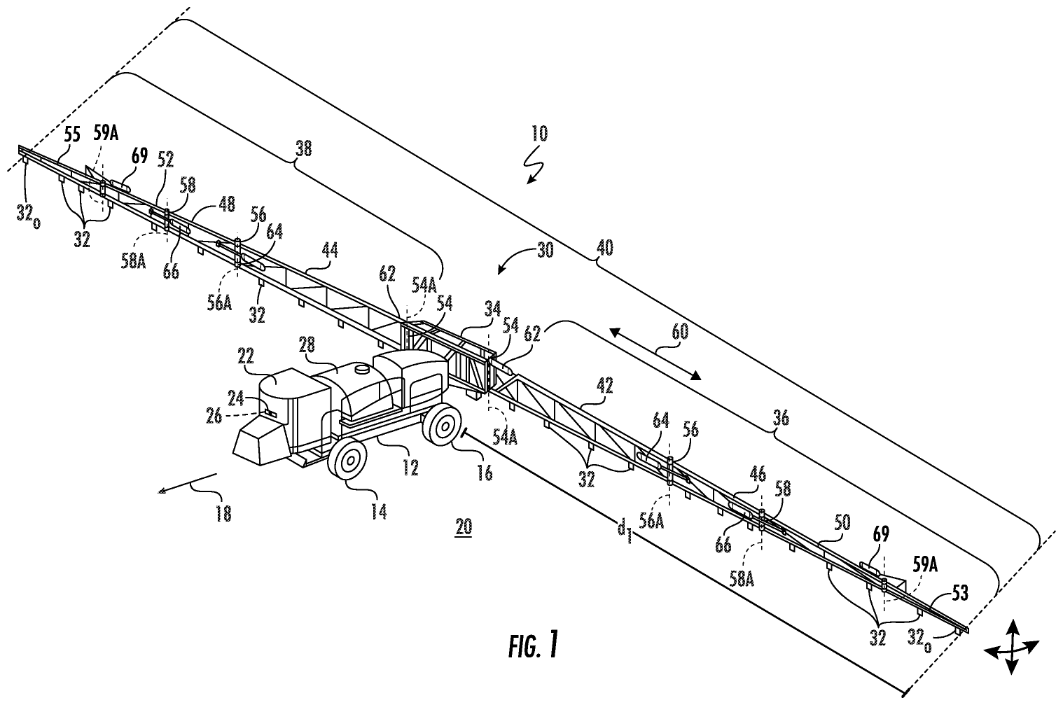

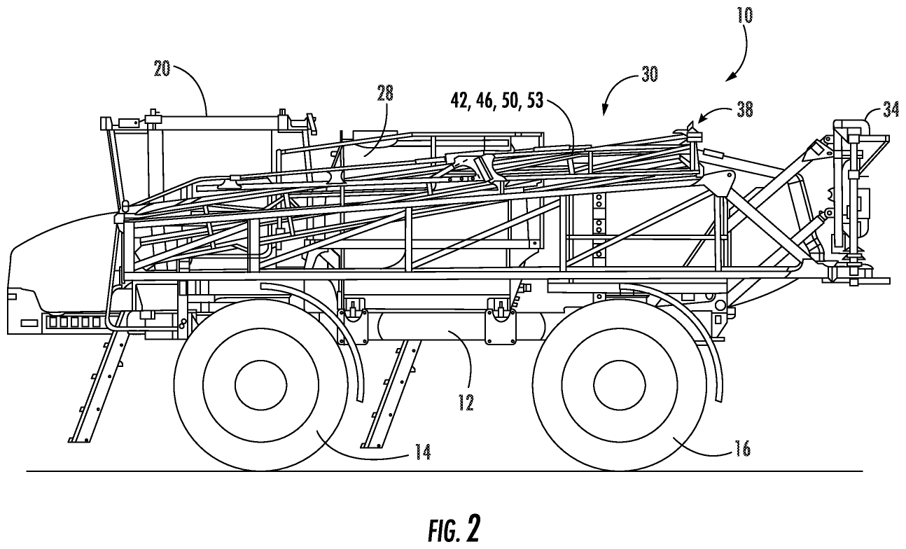

Referring now to FIGS. 1 and 2, an agricultural applicator is generally illustrated as a self-propelled agricultural sprayer 10. However, in alternative embodiments, the agricultural applicator may be configured as any other suitable type of the agricultural applicator configured to perform an agricultural spraying or other product application operations, such as a tractor or other work vehicle configured to haul or tow an applicator implement.

In some embodiments, such as the one illustrated in FIG. 1, the agricultural sprayer 10 may include a chassis 12 configured to support or couple to a plurality components. For example, front and rear wheels 14, 16 may be coupled to the chassis 12. The wheels 14, 16 may be configured to support the agricultural sprayer 10 relative to a ground surface and move the agricultural sprayer 10 in a direction of travel (e.g., as indicated by arrow 18 in FIG. 1) across a field 20. In this regard, the agricultural sprayer 10 may include a power plant, such as an engine, a motor, or a hybrid engine-motor combination, and a transmission configured to transmit power from the engine to the wheels 14, 16.

The chassis 12 may also support a cab 22, or any other form of operator's station, that houses various control or input devices (e.g., levers, pedals, control panels, buttons, and/or the like) for permitting an operator to control the operation of the sprayer 10. For instance, as shown in FIG. 1, the agricultural sprayer 10 may include a user interface or human-machine interface (HMI) 24 for providing messages and/or alerts to the operator and/or for allowing the operator to interface with the vehicle's controller. For instance, the HMI may include any suitable output devices (e.g., screens, audio output devices, lights, haptic devices, and/or the like) for providing messages and/or alerts to an operator. Similarly, the HMI 24 may have one or more user-input devices (e.g., screens, levers, pedals, control panels, buttons, audio input devices, keyboards, keypads, and/or the like) within the cab 22 and/or in any other practicable location.

The chassis 12 may also support one or more tanks, such as a product tank 28 and/or a rinse tank, and a boom assembly 30. The product tank 28 is generally configured to store or hold an agricultural product, such as a pesticide(s) (e.g., an herbicide(s), insecticide(s), rodenticide(s), etc.) and/or a nutrient(s). The agricultural product is conveyed from the product tank 28 through a product circuit including numerous plumbing components, such as interconnected pieces of tubing, for release onto the underlying field 20 (e.g., plants and/or soil) through one or more nozzle assemblies 32 mounted on the boom assembly 30 (or the sprayer 10).

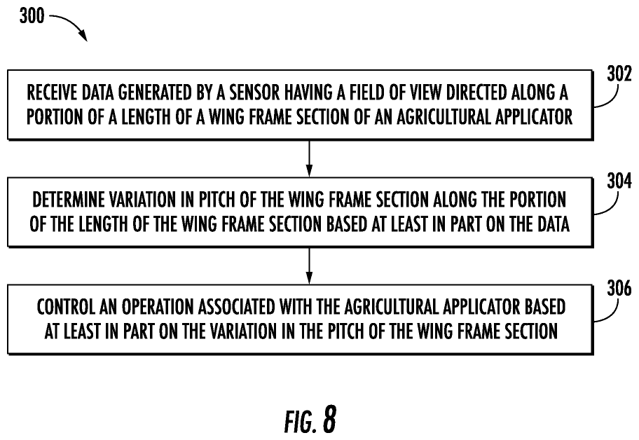

In general, each nozzle assembly 32 is configured to dispense an agricultural product stored within an associated tank (e.g., product tank 28) onto the underlying field 20 and/or plants by a pump 72 (FIG. 7). In this regard, each nozzle assembly 32 may include a nozzle valve and an associated spray tip or spray nozzle. In several embodiments, the operation of each nozzle valve may be individually controlled such that the valve regulates the flow rate of the agricultural product through the associated nozzle assembly 32, and thus, the flow rate of the agricultural product dispensed from the respective spray nozzle. Such control of the operation of the nozzle valve may also be used to achieve the desired spray characteristics for the output or spray fan expelled from the associated spray nozzle, such as a desired droplet size and/or spray pattern. For instance, the nozzle valve may be configured to be pulsed between open/closed positions relative to an orifice of the adjacent spray nozzle at a given frequency and duty cycle (e.g., using a pulse width modulation (PWM) technique) to achieve the desired flow rate and spray characteristics for the respective nozzle assembly 32.

As shown in FIGS. 1 and 2, the boom assembly 30 can include a central frame section 34 that supports first and second boom arms 36, 38 (alternately referred to herein as “first and second wing frame sections 36, 38”). The first and second boom arms 36, 38 are generally movable between an operative or unfolded working position (FIG. 1) and an inoperative or folded transport position (FIG. 2). When distributing the agricultural product, the first and/or second boom arm 36, 38 extends generally laterally outward from the agricultural sprayer 10 in the operative position in order to cover wide swaths of the underlying ground surface, as illustrated in FIG. 1. When extended, each boom arm 36, 38 defines a first lateral length or distance d₁ defined between the central frame section 34 and an outer nozzle assembly 32ₒ and/or an outer end portion of the boom arms 36, 38. Further, the boom arms 36, 38, when both unfolded, define a field swath 40 between the respective outer nozzle assemblies 32ₒ of the first and second boom arms 36, 38 that is generally commensurate with an area of the field 20 to which the agricultural sprayer 10 covers during a pass across a field 20 to perform the agricultural operation. However, it will be appreciated that in some embodiments, a single boom arm 36, 38 may be utilized during the application operation. In such instances, the field swath 40 may be an area defined between a pair of nozzle assemblies 32 of the single boom arm 36, 38 that are furthest from one another in the lateral direction 60.

Each wing frame section or boom arm 36, 38 of the boom assembly 30 may generally include one or more frame sections or “boom sections.” For instance, in the illustrated embodiment, the first boom arm 36 includes three boom sections, namely a first inner boom section 42, a first middle boom section 46, and a first outer boom section 50. Similarly, the second boom arm 38 includes three boom sections, namely a second inner boom section 44, a second middle boom section 48, and a second outer boom section 52. In such an embodiment, the first and second inner boom sections 42, 44 may be pivotably coupled to the central frame section 34 at pivot joints 54. Similarly, the first and second middle boom sections 46, 48 may be pivotably coupled to the respective first and second inner boom sections 42, 44 at pivot joints 56, while the first and second outer boom sections 50, 52 may be pivotably coupled to the respective first and second middle boom sections 46, 48 at pivot joints 58. In some instances, each boom arm 36, 38 of the boom assembly 30 may additionally include a breakaway boom section, such as a first breakaway boom section 53 of the first boom arm 36 and a second breakaway boom section 55 of the second boom arm 38, where the first and second breakaway boom sections 53, 55 are pivotably coupled to the respective first and second outer boom sections 50, 52 at pivot joints 59. As is generally understood, pivot joints 54, 56, 58, 59 may be configured to allow relative pivotal motion between the adjacent boom sections of each boom arm 36, 38. For example, the pivot joints 54, 56, 58, 59 may allow for articulation of the various boom sections between the fully extended or working position (e.g., as shown in FIG. 1), in which the boom sections are unfolded along a lateral direction 60 of the boom assembly 30 to allow for the performance of an agricultural spraying operation, and the transport position (FIG. 2), in which the boom sections are folded inwardly to reduce the overall width of the boom assembly 30 along the lateral direction 60.

Moreover, as shown in FIG. 1, the boom assembly 30 may include actuators to enable pivoting or folding of the boom arms 36, 38. For instance, the boom assembly 30 may include inner fold actuators 62 coupled between the inner boom sections 42, 44 and the central frame section 34 to enable pivoting or folding of the inner boom section 42, 44 relative to the central frame section 34 about a pivot axis 54A defined by the pivot joints 54 between a plurality of angles in a fore-aft direction. For instance, the plurality of angles can include a storage angle when one or both of the boom arms 36, 38 are positioned in the folded, inoperable position. One or both of the boom arms 36, 38 can also be rotated to a default angle relative to the central frame section 34 in which one or both of the boom arms 36, 38 extend a default direction from the central frame section 34 in the operative position. Additionally, the boom assembly 30 may also include middle fold actuators 64 coupled between each inner boom section 42, 44 and its adjacent middle boom section 46, 48, outer fold actuators 66 coupled between each middle boom section 46, 48 and its adjacent outer boom section 50, 52, and breakaway fold actuators 69 coupled between each outer boom section 50, 52 and its adjacent breakaway boom section 53, 55. As such, by retracting/extending the middle fold actuators 64, the outer fold actuators 66, and the breakaway fold actuators 69, each middle, outer, and breakaway boom section 46, 48, 50, 52, 53, 55 may be pivoted or folded relative to its respective inwardly adjacent boom section 42, 44, 46, 48 about a respective pivot axis 56A, 58A, 59A.

When moving to the transport position, the boom assembly 30 and fold actuators 62, 64, 66, 69 are typically oriented such that the pivot axes 54A, 56A, 58A, 59A are generally parallel to the vertical direction and, thus, the various boom sections 42, 44, 46, 48, 50, 52, 53, 55 of the boom assembly 30 are configured to be folded horizontally (e.g., parallel to the lateral direction 60) about the pivot axes 54A, 56A, 58A, 59A to keep the folding height of the boom assembly 30 as low as possible for transport. However, it should be appreciated that some or all of the pivot axes 54A, 56A, 58A, 59A may be oriented along any other suitable direction. It should additionally be appreciated that, although each boom arm 36, 38 is shown in FIGS. 1 and 2 as including four individual boom sections coupled along opposed sides of the central boom section, each boom arm 36, 38 may generally have any suitable number of boom sections.

Referring now to FIG. 3, a simplified, schematic top-down view of some embodiments of a boom arm of a boom assembly (e.g., the boom arm 36 of the boom assembly 30) is illustrated in accordance with aspects of the present subject matter, particularly illustrating the boom arm in an expected position (e.g., in solid lines) and being deflected in a forward and a rearward direction (e.g., both shown in dashed lines). It should be appreciated that, while only the boom arm 36 and the central frame section 34 are shown in FIG. 3, the other boom arm 38 may be positioned essentially mirrored to boom arm 36 about the central frame section 34 (FIGS. 1 and 2).

Prior to performing an agricultural operation with the boom assembly 30, each boom arm 36, 38 may extend, like boom arm 36 shown in solid lines in FIG. 3, along the first lateral distance d₁ away from the sprayer 10 and/or the central frame section 34 along a default axis a_{d}. In various embodiments, the default axis a_{d} may generally be offset ninety degrees relative to the vehicle travel direction such that the default axis a_{d} is generally aligned with the lateral direction 60. During operation, however, various forces may be placed on the boom assembly 30 causing the boom arms 36, 38 and, consequently, the nozzle assemblies 32 positioned along the boom arms 36, 38, to be deflected or repositioned relative to the central frame section 34 and/or sprayer 10. For instance, a portion of the boom assembly 30 may be deflected from an assumed or a default position dₚ due to high dynamic forces encountered when the sprayer 10 is turned, accelerated, or decelerated. In addition, terrain variations and weather variances may also cause deflection of the boom assembly 30. Further, a portion of the boom assembly 30 may come in contact with an object, thereby leading to deflection of the boom assembly 30.

The boom arm 36 may be deflected from its default position dₚ in a forward direction (e.g., the direction of travel 18) into a forward deflected position d_{f} or, alternately, in an aft direction opposite the direction of travel 18, into an aft deflected position dₐ, as generally illustrated in FIG. 3. In the deflected positions d_{f}, dₐ, the outer nozzle assembly 32ₒ may be positioned a second lateral distance de from the central frame section 34, which may be less than the first lateral distance d₁ due to a curvature of the boom assembly 30. Accordingly, a lateral variance v in the lateral direction 60 is formed between the first and second lateral distances d₁, d₂. This lateral variance v may lead to a misapplication of an agricultural substance to the underlying field 20, which may be in the form of an overapplication or an underapplication of the agricultural product. For instance, the area of the underlying field 20 between the central frame section 34 and the outer nozzle assembly 32ₒ may have an overapplication of the agricultural product applied thereto when the boom arm 36 is deflected, while the portion of the underlying field 20 below the variance v may have an underapplication of the agricultural product applied thereto. In addition to creating the lateral variance v, the deflection of the boom arm 36 also creates an offset OFF1 between the outer nozzle assembly 32ₒ in the default position dₚ and the deflected positions d_{f}, dₐ along the direction of travel 18, which may also lead to inaccuracies during application of the agricultural product to the underlying field 20, as the deflected nozzles (including the outer nozzle assembly 32ₒ) are at a different position in the field than expected.

In embodiments, such as the one illustrated in FIG. 3 that utilizes a boom arm 36 supported by the central frame section 34 in a cantilevered orientation (or any other non-uniform orientation), an outer nozzle assembly 32ₒ will have a greater deflection magnitude from its default position dₚ than an inner nozzle assembly 32ᵢ. Once the deflective force is overcome and/or no longer present, the boom arm 36 will move back towards its default position dₚ. In some embodiments, the movement of the boom arm 36 may generally occur as harmonic oscillations across the default axis a_{d} such that the boom arm 36 may move from a position at least partially aft of the default axis a_{d} to the default position dₚ and then to a position at least partially fore of the default position dₚ and so on. During the oscillations, an acceleration of an inner nozzle assembly 32ᵢ will be less than the outer nozzle assembly 32ₒ due to the varied deflection magnitudes along the boom arm 36.

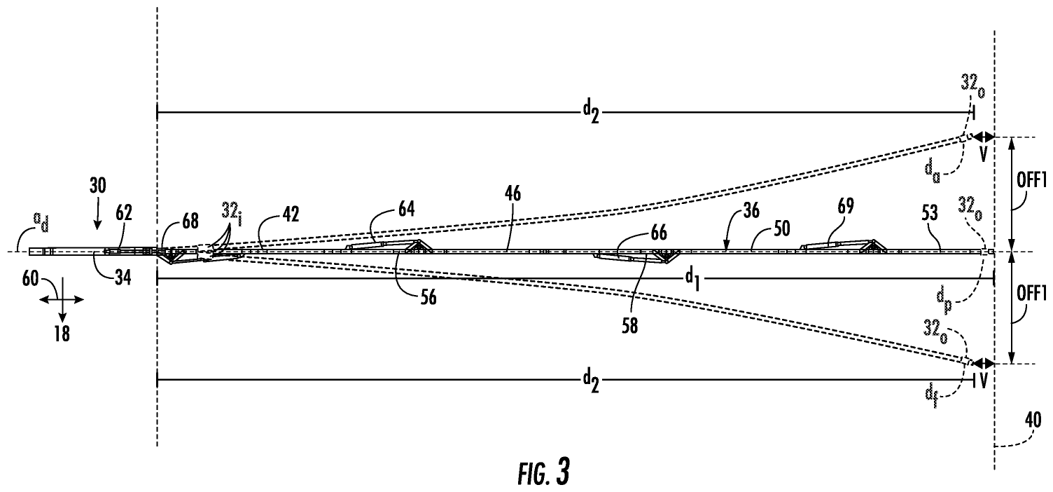

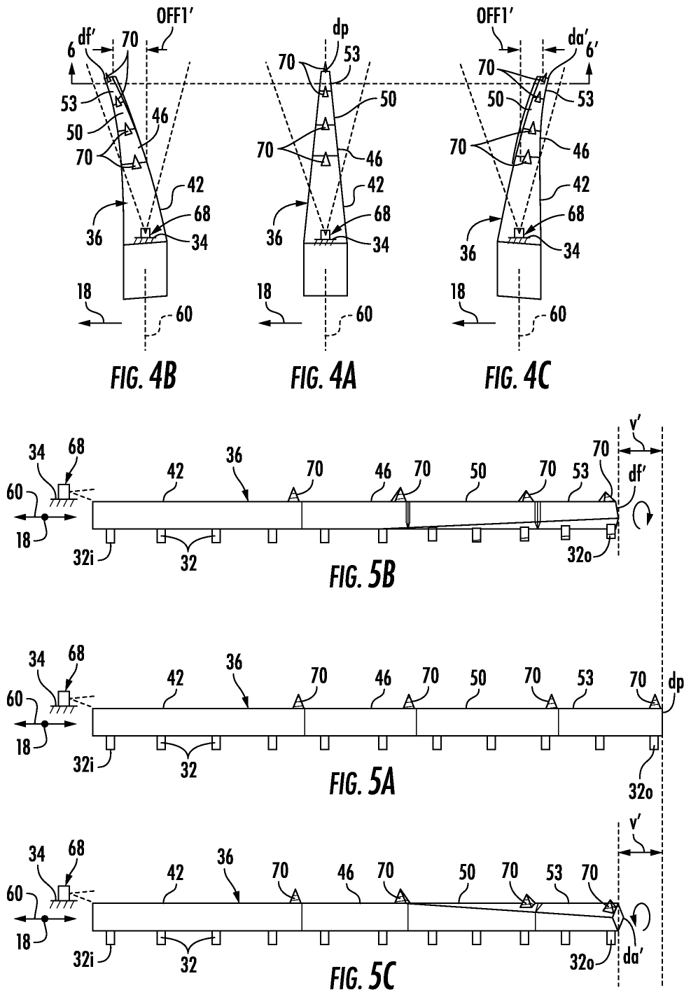

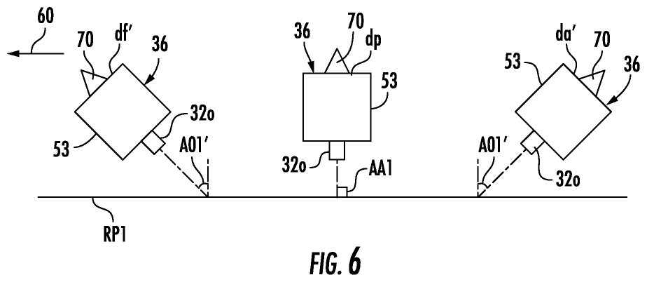

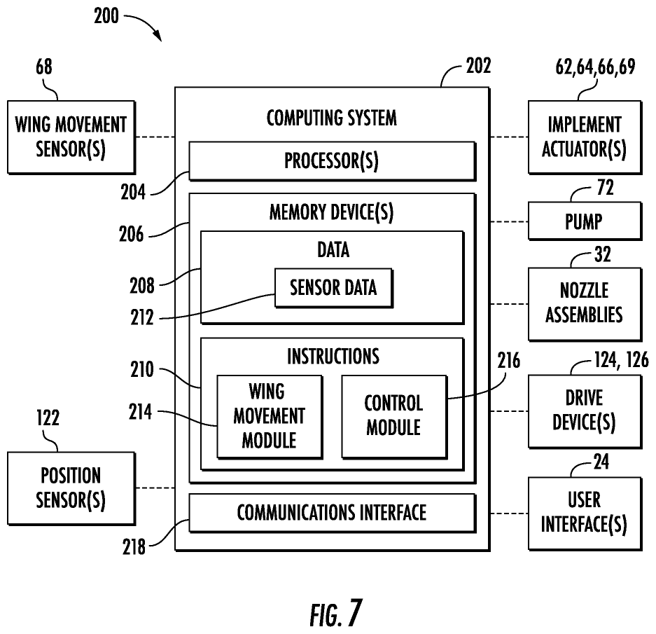

In some instances, depending on the speed of the deflection in the fore direction (e.g., the forward direction of travel 18) or in the aft direction (e.g., opposite the forward direction of travel 18) and depending on configuration of the boom arms 36, 38 (e.g., the lengths d₁ of the boom arms 36, 38), the boom arms 36, 38 may additionally experience pitch. Particularly, referring to FIGS. 4A-6, various simplified, schematic views of some embodiments of a boom arm of a boom assembly are illustrated in accordance with aspects of the present subject matter. For instance, FIGS. 4A-4C illustrate simplified, schematic views along a length of a boom arm (e.g., the boom arm 36), when viewed from above the boom arm proximate a central frame section (e.g., the central frame section 34 (shown schematically)), particularly illustrating the boom arm having varying pitch while deflecting in a forward and a rearward direction from a default position. Similarly, FIGS. 5A-5C illustrate simplified, schematic rear views of a boom arm (e.g., the boom arm 36) having varying pitch while deflecting in a forward and a rearward direction from a default position. Additionally, FIG. 6 illustrates a simplified, schematic view of the outer end of a boom arm (e.g., the boom arm 36) and an outermost nozzle assembly (e.g., nozzle assembly 32ₒ) taken with reference to section line 6-6′ across FIGS. 4A-4C while the boom arm deflects in a forward and a rearward direction from a default position. Again, while only the boom arm 36 is shown in FIGS. 4A-6, it should be appreciated that the boom arm 38 may move in substantially the same manner, from the opposite side of the central frame section 34.

As shown in FIGS. 4A-5C, when the boom arm 36 moves from the default position dₚ shown in FIGS. 4A and 5A with the forward direction of travel 18 to a forward deflected position d_{f}′ shown in FIGS. 4B and 5B or, alternately, against or opposite the direction of travel 18 to an aft deflected position dₐ′ shown in FIGS. 4C and 5C, one or more of the boom sections 42, 46, 50, 53 of the boom arm 36 pivot relative to each other in addition to pitching to varying degrees. For instance, in the examples shown in FIGS. 4B and 5B, the boom arm 36 pitches about the length of the boom arm 36 such that the upper surface of the boom arm 36 is pivoted forward along the forward direction of travel 18. Conversely, in the examples shown in FIGS. 4C and 5C, the boom arm 36 pitches about the length of the boom arm 36 such that the upper surface of the boom arm 36 is pivoted aft, opposite the direction of travel 18. Generally, as the boom arms 36, 38 pitch, the nozzle assemblies 32 positioned on the pitching portions of the boom arms 36, 38 also pitch. For instance, as particularly shown in FIG. 6, the outer nozzle assembly 32ₒ is at a first angle of attack AA1 relative to a reference plane (e.g., field surface, crop canopy, etc.) when the boom arm 36 is in the default position dₚ and is offset from the first angle of attack AA1 by an angular offset AO1′ when pitched to the deflected and pitched positions d_{f}′, dₐ′.

The outer boom sections generally deflect about their length (i.e., pitch) with a greater magnitude than the next outer-most sections. For example, in the examples illustrated in FIGS. 4B-4C and 5B-5C, the breakaway boom section 53 pitches a greater amount along its length than the outer boom section 50, the outer boom section 50 pitches a greater amount along its length than the middle boom section 46, and the middle boom section 46 pitches a greater amount along its length than the inner boom section 42. As such, the outer nozzle assembly 32ₒ (FIGS. 5A-5C) will have a greater deflection magnitude (e.g., the angular offset AO1′) from its default position dₚ than the inner nozzle assembly 32ᵢ (FIGS. 5A-5C). Further, as shown in FIGS. 4B-4C and 5B-5C, the pitch along the length of each of the boom sections 42, 46, 50, 53 may vary (e.g., generally increase) from the inner end to the outer end. For instance, the outer end of the breakaway section 53 (and the outer nozzle assembly 32ₒ), pitches more than the inner end of the breakaway section 53 (and the next inward nozzle assembly on the breakaway section 53), the outer end of the outer boom section 50 (and the outer nozzle assembly on the outer boom section 50) pitches more than the inner end of the outer boom section 50 (and the next inward nozzle assembly(ies) on the outer boom section 50), and so forth. It should be appreciated that the variation in pitch may be linear or non-linear. It should further be appreciated that, in some instances, a variation v′ (FIGS. 5A-5C) in the lateral direction 60 is experienced between the outer nozzle 32ₒ in the default position dₚ and the deflected positions d_{f}′, dₐ′ when there is both fore-aft pivoting and pitching. The variation v′ may be equal to or different from the variation v (FIG. 3) in the lateral direction 60 experienced when there is only fore-aft pivoting. In addition to creating the lateral variance v′, the combined deflection and pitching of the boom arm 36 also creates an offset OFF1′ between the outer nozzle assembly 32ₒ in the default position dₚ and the deflected positions d_{f}′, dₐ′ along the direction of travel 18. The offset OFF1′ may equal to or different from the offset OFF1 (FIG. 3) along the direction of travel 18 experienced when there is only fore-aft pivoting.

Generally, when the boom arm 36 is pivoting and pitching towards one of the deflected positions d_{f}′, dₐ′, the boom sections (and associated nozzles 32) have varying acceleration, with the outermost boom section (e.g., the breakaway boom section 53) and its outermost nozzle 32 (e.g., outer nozzle 32ₒ) having the highest acceleration relative to central frame section 34 along the direction of travel 18 and the highest acceleration relative to the central frame section 34 in the pitching direction (e.g., about its length). The movement into the deflected positions d_{f}′, dₐ′, and the resulting varying angular offset AO1′, lateral variance v′, and offset OFF1′, may lead to a misapplication of an agricultural substance to the underlying field 20, which may be in the form of an overapplication or an underapplication of the agricultural product. For instance, the area of the underlying field 20 between the central frame section 34 and the outer nozzle assembly 32ₒ may have an overapplication of the agricultural product applied thereto when the boom arm 36 is deflected and pitched, while the portion of the underlying field 20 below the variance v′ may have an underapplication of the agricultural product applied thereto. Similarly, the offsets OFF1′ and AO1′ between the outer nozzle assembly 32ₒ in the default position dₚ and the deflected positions d_{f}, dₐ′ may also lead to inaccuracies during application of the agricultural product to the underlying field 20, as the nozzles 32 are not above the area expected for the position of the sprayer 10 along the direction of travel 18 and are not in a default angular position (e.g., offset from the angle of attack AA1). For instance, the greater the offset from the default angle of attack AA1, the further the spray must travel before reaching the reference plane RP1, which can cause the spray to be dispersed over a less controlled (e.g., wider) area, with less density.

Thus, in accordance with aspects of the present subject matter, one or more wing movement sensors 68 are provided in association with the sprayer 10 for monitoring at least the pitch of the boom arms 36, 38. For instance, as particularly shown in FIGS. 3-5C, the sensor(s) 68 may be positioned such that each of the sensor(s) 68 has a field of view directed along at least a portion of the length d₁ of the associated boom arm 36, 38. For example, the sensor(s) 68 may be supported on one or more of the central frame section 34, the inner boom section(s) 42, 44, the middle boom section(s) 46, 48, the outer boom section(s) 50, 52, the breakaway boom section(s) 53, 55, or at any other suitable location on the sprayer 10. As particularly shown in FIGS. 3-5C, in some instances, the sensor(s) 68 are particularly supported on the sprayer 10 proximate the inner end of the respective boom arm 36, 38 (e.g., on the central frame section 34), such that a majority of the length d₁ of the respective boom arm 36, 38 may be within the field of view of the sensor(s) 68. In some instances, the entire length d₁ of the respective boom arm 36, 38 may be within the field of view of the sensor(s) 68. The sensor(s) 68 may include one or more cameras (including stereo camera(s), and/or the like), LIDAR sensors (e.g., single and/or multiple frequency LIDAR sensors), and/or the like, that allows the sensor(s) 68 to generate image data, point-cloud data, and/or the like indicative of the orientation of the associated boom arm(s) 36, 38, at least along the portion of the length d₁ of the associated boom arm(s) 36, 38.

In some instances, it may be difficult to identify different boom sections of the boom arm(s) 36, 38 from the data generated by the sensor(s) 68. As such, in some embodiments, the boom arm(s) 36, 38 may further be configured to support one or more targets 70, where the target(s) 70 extend from the boom arm(s) 36, 38. For instance, as shown in FIGS. 4A-6, the target(s) 70 may be positioned on one or more boom section(s) of the boom arm(s) 36, 38. For example, in some embodiments, the target(s) 70 may be positioned on each boom section of the boom arm(s) 36, 38. In particular embodiments, each of the targets 70 is positioned at an end (e.g., outer end) of the respective boom section, such that the end of each boom section may be more easily identified from the data generated by the sensor(s) 68. However, the target(s) 70 may be positioned in any other suitable manner along the boom arm(s) 36, 38.

The target(s) 70 are configured to be easily identifiable from the boom arm(s) 36, 38 in the data generated by the sensor(s) 68. For instance, as shown in the illustrated embodiment, the targets 70 extend outwardly from an upper surface of the boom arm(s) 36, 38. However, it should be appreciated that the target(s) 70 may extend from any other suitable portion of the boom arm(s) 36, 38 such that the target(s) 70 is visible to the sensor(s) 68. Further, each of the target(s) 70 may be asymmetrical in at least one plane of geometry and/or is asymmetrical in color (e.g., in shading, pattern, and/or the like) such that fore-aft pivoting of the boom section(s) and/or pitching of the boom section(s) of the boom arm(s) 36, 38 is easy to identify from the target(s) 70. For example, as shown in the illustrated embodiment, each of the target(s) 70 is asymmetrical in both geometry and coloring. For instance, each of the target(s) 70 is shown as being generally pyramidal in shape, with adjacent sides having different shadings. However, it should be appreciated that the target(s) 70 may have any other suitable geometry and/or coloring. It should further be appreciated that, in some embodiments, the targets 70 are substantially identical. However, in other embodiments, the targets 70 may vary in geometry and/or color such that the targets 70 are more easily associated with different positions along the length of the boom arm(s) 36, 38.

In some embodiments, the target(s) 70 may be at least partially aligned along the length d₁ of the associated boom arm(s) 36, 38, such that the sensor(s) 68 may easily identify movement of the boom arm(s) 36, 38 relative to the central frame section 34. For instance, as shown in FIG. 4A, when the boom arm(s) 36, 38 is in the default position dₚ, the target(s) 70 may be at least partially aligned along the lateral direction 60. As such, depending on the position of the sensor(s) 68, the target(s) 70 may substantially overlap in the field of view of the sensor(s) 68 when the boom arm(s) 36, 38 is in the default position dₚ so that the data generated by the sensor(s) 68 essentially shows a single target 70. Thus, when the boom arm(s) 36, 38 move from the default position dₚ, such as to the forward deflected and pitched position d_{f}′ or the aft deflected position dₐ′, at least some of the target(s) 70 are no longer laterally aligned within the field of view of the sensor(s) 68, such that more than a single target 70 is visible in the data generated by the sensor(s) 68.

As will be described below in greater detail, a computing system may be configured to receive the data generated by the sensor(s) 68 and identify variation in pitch along the boom arm(s) 36, 38 based at least in part on the data generated by the sensor(s) 68. In some embodiments, the computing system may further be configured to identify variation in fore-aft deflection. Based on the variation in pitch and/or fore-aft deflection along the boom arm(s) 36, 38, the computing system may be configured to control the operation of one or more components associated with the sprayer 10 to improve, directly or indirectly, the precision of the spraying process.

Referring now to FIG. 7, a schematic view is illustrated of one embodiment of an agricultural system 200 for monitoring spray booms of an agricultural applicator in accordance with aspects of the present subject matter. In general, the system 200 will be described herein with reference to the sprayer 10 having the boom assembly 30 as described above with reference to FIGS. 1-6. However, it should be appreciated that the disclosed system 200 may generally be utilized with any other suitable sprayer or other implement having any other suitable sprayer or implement configuration. Additionally, it should be appreciated that, for purposes of illustration, communicative links or electrical couplings of the system 200 shown in FIG. 7 are indicated by dashed lines.

In several embodiments, the system 200 may include a computing system 202 and various other components configured to be communicatively coupled to and/or controlled by the computing system 202, such as the wing movement sensor(s) 68 configured to generate data indicative of movement of the wing or boom arms 36, 38 (e.g., pitching movement, fore-aft movement, and/or the like), the implement actuator(s) (e.g., fold actuator(s) 62, 64, 66, 69, etc.), drive device(s) of the sprayer 10 (e.g., an engine 124, a transmission 126, etc.), a user interface(s) (e.g., the HMI 24), nozzle assembly(ies) (e.g., valve(s) of the nozzle assemblies 32) for distributing agricultural product onto a field, and/or a pump(s) (e.g., the pump 72) for delivering agricultural product to the nozzle assemblies 32. As indicated above, the user interface(s) 24 may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like. Additionally, the computing system 202 may be communicatively coupled to one or more position sensors 122 configured to generate data indicative of the location of the sprayer 10, such as a satellite navigation positioning device (e.g., a GPS system, a Galileo positioning system, a Global Navigation satellite system (GLONASS), a BeiDou Satellite Navigation and Positioning system, a dead reckoning device, and/or the like).

In general, the computing system 202 may correspond to any suitable processor-based device(s), such as a computing device or any combination of computing devices. Thus, as shown in FIG. 7, the computing system 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

It should be appreciated that the computing system 202 may correspond to an existing computing device for the sprayer 10 or may correspond to a separate processing device. For instance, in one embodiment, the computing system 202 may form all or part of a separate plug-in module that may be installed in operative association with the sprayer 10 to allow for the disclosed system and method to be implemented without requiring additional software to be uploaded onto existing control devices of the sprayer 10.

In several embodiments, the data 208 may be stored in one or more databases. For example, the memory 206 may include a sensor database 212 for storing data generated by the sensors 68, 122. For instance, each of the wing movement sensor(s) 68 may be configured or controlled by the computing system 202 to continuously or periodically capture (generate) data associated with movement of the boom arm(s) 36, 38. For instance, the data generated by the sensor(s) 68 may be at least indicative of pitching movement of one or more boom sections of the boom arm(s) 36, 38. In some instance, the data generated by the sensor(s) 68 may also be indicative of fore-aft movement of one or more boom sections of the boom arm(s) 36, 38, lateral rolling of one or more boom sections of the boom arm(s) 36, 38, and/or the like. Additionally, the data from the sensor(s) 68 may be taken with reference to the position of the sprayer 10 within the field based on the position data from the position sensor(s) 122. The data transmitted to the computing system 202 from the sensor(s) 68 may be stored within the sensor database 212 for subsequent processing and/or analysis. It should be appreciated that, as used herein, the term “sensor data 212” may include any suitable type of data received from the sensor(s) 68, 122 that allows for the movement of the boom arm(s) 36, 38 to be accurately analyzed including image data, point-cloud data, GPS coordinates, and/or other suitable type of data.

The instructions 210 stored within the memory 206 of the computing system 202 may be executed by the processor(s) 204 to implement a wing movement module 214. In general, the wing movement module 214 may be configured to assess the sensor data 212 deriving from the sensor(s) 68, 122, e.g., using one or more data analysis or processing techniques, algorithms, and/or the like stored within the memory, to automatically determine movement of the boom arm(s) 36, 38. For example, the wing movement module 214 may analyze the images from the sensor data 212 generated by the sensor(s) 68, when the sensor(s) 68 include imaging devices (e.g., camera(s)), using any suitable image processing techniques. Suitable processing or analyzing techniques may include performing spatial analysis on received images or image data. For instance, geometric or spatial processing algorithms, shape detection and/or edge-finding or perimeter-finding algorithms, and/or the like may differentiate the shape, color, edges, and/or the like of the boom arm(s) 36 and/or target(s) 70 from expected field features (e.g., plants, residue, soil, rocks, and/or the like) in the images. Similar processing techniques may be used by the wing movement module 214 when the sensor(s) 68 include LIDAR sensors to analyze point clouds generated from the sensor data 212.

As indicated above, the data generated by the sensor(s) 68 may be indicative of pitching movement/or fore-aft movement of the different boom sections of the boom arm(s) 36, 38, which may be used to determine an actual position of the different boom sections of the boom arm(s) 36, 38. More particularly, the wing movement module 214 may evaluate the image data, point cloud data, and/or the like generated by the sensor(s) 68 to determine when there is variation in the pitch along the length of the boom arm(s) 36, 38. In some embodiments, the wing movement module 214 may identify the different boom section(s) (e.g., boom sections 42, 44, 46, 48, 50, 52, 53, 55) and/or the target(s) 70 from the data generated by the sensor(s) 68 and then determine based on a comparison between at least two instances within a defined time period a change in orientation, acceleration, movement direction, and/or the like of the boom section(s) and/or target(s) 70, which may, in turn, be at least indicative of variation in the pitch along the wing frame section(s) 36, 38.

For instance, the wing movement module 214 may monitor the position or orientation of a single target 70 positioned on one of the boom sections (e.g., the breakaway boom section 53, 55) of each boom arm 36, 38 based on the data generated by the sensor(s) 68 and determine the variation in the pitch of the wing frame sections (e.g., boom arms 36, 38) based at least in part on the orientation of the targets 70. Particularly, the wing movement module 214 may compare an orientation of the target 70 on a respective boom arm 36, 38 at a first time instance to an orientation of the target 70 on the respective boom arm 36, 38 at a second time instance to determine whether the target 70 has pitched and/or if the target 70 has moved in the fore-aft direction. If the target(s) 70 of the boom arm(s) 36, 38 has pitched, the wing movement module 214 may determine a variation in the pitch along the boom arm(s) 36, 38 based on the change in pitch between the two instances. For instance, the change in pitch of the target(s) 70 and/or the change in fore-aft position of the target(s) 70 over the predefined time may be used to determine the variation in pitch along the portion of the length of the boom arm(s) 36, 38 using a look-up table, an algorithm, and/or the like stored, for example, in the memory 206. In some embodiments, one of the instances may be the assumed or default position dₚ, dₚ′ of the boom arm(s) 36, 38.

Similarly, if more than one target 70 is positioned on the boom arm(s) 36, 38, the wing movement module 214 may monitor the position or orientation of each target 70 on the boom arm(s) 36, 38 based on the data generated by the sensor(s) 68 and determine the variation in the pitch of the wing frame sections (e.g., boom arms 36, 38) based at least in part on the orientation of the targets 70 on each boom arm 36, 38. For instance, the targets 70 on a particular arm 36, 38 may be spaced apart along at least a portion of the length of the boom arm 36, 38, with each target 70 on the boom arm 36, 38 being within the field of view of the sensor(s) 68. As the boom sections pitch, the targets 70 may have different orientations relative to each other. The wing movement module 214 may determine the variation in the pitch of the boom arm 36, 38 based at least in part on a comparison of an orientation of at least two of the targets 70 on the boom arm 36, 38 at a given instance or across multiple instances. For instance, the difference in pitch of between the targets 70 and/or the difference in fore-aft position of the targets 70 on a particular boom arm 36, 38 at a given instance or over the predefined time may be used to determine the variation in pitch along the portion of the length of the boom arm(s) 36, 38 using a look-up table, an algorithm, and/or the like stored, for example, in the memory 206.

It should be appreciated that, in some instances, the wing movement module 214 may first evaluate the data generated by the sensor(s) 68, 122 to determine whether fore or aft movement of the boom arm(s) 36, 38 has occurred and, if so, whether a variation in the pitching has also occurred. For instance, if a magnitude of fore-aft movement of the boom arm(s) 36, 38 greater than a threshold fore-aft magnitude is detected based on the data generated by the sensor(s) 68, the wing movement module 214 may then evaluate variation of the pitch of the boom arm(s) 36, 38.

However, in one embodiment, the wing movement module 214 may be configured to control an operation of the user interface(s) 24 to display or otherwise indicate the data generated by the sensor(s) 68 and, in response, receive an indication from an operator when the boom arm(s) 36, 38 have pitched. For instance, an operator may monitor the data displayed via the user interface(s) 24 and indicate (e.g., via the user interface(s) 24) when the boom arm(s) 36, 38 have pitched and optionally, an indication of a direction and/or magnitude of the pitch.

The instructions 210 stored within the memory 206 of the computing system 202 may also be executed by the processor(s) 204 to implement a control module 216. For instance, the control module 216 be configured to automatically control an operation associated with the agricultural applicator 10 based on the variation in the pitch along the boom arm(s) 36, 38. For example, in some embodiments, when it is determined that the pitch is greater than a threshold pitch, the control module 216 may be configured to control an operation associated with the agricultural applicator 10. Particularly, in one embodiment, the control module 216 may be configured to control an operation associated with the agricultural applicator 10 when a variation in the pitch along the wing frame section 36, 38 is greater than a threshold variation. In some instances, the control module 216 may be configured to automatically adjust at least one of a ground speed of the agricultural applicator 10 (e.g., by controlling an operation of drive device(s) 124, 126), controlling an operation of the user interface(s) 24 to indicate the variation in the pitch of the wing frame section(s) 36, 38, controlling an actuator (e.g., actuator(s) 62, 64, 66, 69) of the wing frame section(s) 36, 38 to adjust a position of one or more of the boom section(s) of the wing frame section(s) 36, 38, controlling an operation of one or more of the plurality of nozzle assemblies (e.g., valves of the nozzle assembly(ies) 32) and/or associated pump(s) (e.g., pump 72), and/or the like based on the pitch along the boom arm(s) 36, 38.

For instance, in some embodiments, a boom speed or boom acceleration of each nozzle assembly 32 along the boom arm(s) 36, 38 may be calculated based on the detected and/or calculated position of various portions of the boom arm(s) 36, 38 at known time periods determined from the variation in pitch and/or fore-aft movement of the boom arm(s) 36, 38. The boom speed or boom acceleration may be a speed or acceleration of the boom arm(s) 36, 38 proximate to defined positions of each nozzle assembly 32 relative to the central frame section 34. In some examples, the central frame section 34 may be affixed to the sprayer 10 and/or the central frame section 34 of the sprayer 10 such that the central frame section 34 is assumed to move at a common chassis speed as the sprayer 10. Based on the summation of the boom speed, or boom acceleration, with the chassis speed, a nozzle speed/acceleration relative to the field or reference plane may be calculated. In various embodiments, when a product pump 72 is operated at a known flow rate and the nozzle speed is calculated, an application rate (e.g., gallons per acre (GPA)) of agricultural product may be calculated for each nozzle assembly 32 along the boom arm 36. In some instances, a desired application rate of agricultural product may be defined for each position in the field. When applying agricultural product to an underlying field 20, if the calculated application rate (e.g., GPA) of agricultural product within the field 20 deviates from the desired application rate of agricultural product (as prescribed, for example, by an application routine or map received by the computing system 202 and/or stored in the memory 206) of the by more than a predefined percentage, the control module 216 may control the user interface 24 to provide a notification of the deviation and/or areas of a field 20 in which the deviation occurs and/or perform any other control action, such as any of the control actions described above (e.g., control an operation of drive device(s) 124, 126 to change the ground speed of the applicator 10, control actuator(s) 62, 64, 66, 69 to adjust a position of one or more of the boom section(s) of the wing frame section(s) 36, 38, adjust an operation of valves of the nozzle assembly(ies) 32 and/or associated pump(s) 72). In some instances, the control module 216 may also generate a map indicating the resulting application, including areas in the field 20 which may have application variances due to the pitching and fore-aft movement of the boom arm(s) 36, 38 relative to the central frame section 34, based on the data 212 generated by the wing movement sensor(s) 68 and the position sensor(s) 122.

Additionally, as shown in FIG. 7, the computing system 202 may also include a communications interface 218 configured to provide a means for the computing system 202 to communicate with any of the various other system components described herein. For instance, one or more communicative links or interfaces (e.g., one or more data buses) may be provided between the communications interface 218 and the sensor(s) 68, 122 to allow data transmitted from the sensor(s) 68, 122 to be received by the computing system 202. Similarly, one or more communicative links or interfaces (e.g., one or more data buses) may be provided between the communications interface 218 and the user interface(s) 24 to allow operator inputs to be received by the computing system 202 and to allow the computing system 202 to control the operation of one or more components of the user interface(s) 24. Moreover, one or more communicative links or interfaces (e.g., one or more data buses) may be provided between the communications interface 218 and the implement actuator(s) 62, 64, 66, 69, nozzle assemblies 32 (e.g. valves of the nozzle assemblies 32), pump(s) 72, and/or the drive device(s) 124, 126 to allow the computing system 202 to control the operation of one or more components of such components.

Referring now to FIG. 8, a flow diagram of one embodiment of a method 300 for monitoring the quality of application of the agricultural product to the field by monitoring movement of the boom assembly is illustrated in accordance with aspects of the present subject matter. In general, the method 300 will be described herein with reference to the applicator 10 described with reference to FIGS. 1-6, as well as the various system components shown in FIG. 7. However, it should be appreciated that the disclosed method 300 may be implemented with work vehicles and/or implements having any other suitable configurations, and/or within systems having any other suitable system configurations. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (302), the method 300 may include receiving data generated by a sensor having a field of view directed along a portion of a length of a wing frame section of an agricultural applicator. For instance, as described above, the computing system 202 may receive the data generated by the sensor(s) 68, where each of the sensor(s) 68 has a field of view directed along at least a portion of the length of the wing frame section (e.g., boom arm(s) 36, 38) of the agricultural applicator 10.

Further, at (304), the method 300 may include determining variation in pitch of the wing frame section along the portion of the length of the wing frame section based at least in part on the data. For example, as indicated above, the computing system 202 may be configured to determine variation in pitch of the wing frame section (e.g., boom arm(s) 36, 38) along the portion of the length of the wing frame section within at least the field of view of the sensor(s) 68 based at least in part on the data generated by the sensor(s) 68.

Additionally, at (306), the method 300 may include controlling an operation associated with the agricultural applicator based at least in part on the variation in the pitch of the wing frame section. For instance, as described above, the computing system 202 may control an operation associated with the agricultural applicator 10 based at least in part on the variation in the pitch of the wing frame section (e.g., boom arm(s) 36, 38). For example, the computing system may control an operation of the user interface 24, the drive device(s) 124, 126, the actuator(s) 62, 64, 66, 69, the nozzle assembly(ies) 32 (e.g., valves of the nozzle assembly(ies) 32) and/or associated pump(s) 72), and/or the like based at least in part on the variation in the pitch of the wing frame section (e.g., boom arm(s) 36, 38).

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for monitoring spray booms of an agricultural applicator, the agricultural system comprising:
a boom assembly of an agricultural applicator, the boom assembly comprising a central frame section and a wing frame section pivotably coupled to the central frame section, the wing frame section extending along a length defined between a first end and a second end;
a plurality of nozzle assemblies spaced apart along the boom assembly;
a sensor having a field of view directed along a portion of the length of the wing frame section, the sensor being configured to generate data indicative of a pitch of the wing frame section along the portion of the length of the wing frame section;
a computing system communicatively coupled to the sensor, the computing system being configured to:
receive the data generated by the sensor;
determine variation in the pitch of the wing frame section along the portion of the length of the wing frame section based at least in part on the data; and
control an operation associated with the agricultural applicator based at least in part on the variation in the pitch of the wing frame section.

2. The agricultural system of claim 1, further comprising a first target on the wing frame section, the first target being within the field of view, the computing system being configured to determine the variation in the pitch of the wing frame section based at least in part on an orientation of the first target.

3. The agricultural system of claim 2, further comprising a second target on the wing frame section, the first target and the second target being spaced apart along the portion of the length of the wing frame section, the second target being within the field of view, the computing system being configured to determine the variation in the pitch of the wing frame section based at least in part on a comparison of an orientation of the second target to the orientation of the first target.

4. The agricultural system of claim 3, wherein the wing frame section comprises a first wing frame section and a second wing frame section, the first wing frame section being pivotably coupled to the central frame section, the second wing frame section being pivotably coupled to the first wing frame section,
wherein the first target is on the first wing frame section and the second target is on the second wing frame section.

5. The agricultural system of claim 2, wherein the first target is asymmetric in at least one of color or shape.

6. The agricultural system of claim 1, wherein the computing system is configured to control the operation associated with the agricultural applicator when the variation in the pitch of the wing frame section is greater than a threshold variation.

7. The agricultural system of claim 1, wherein the computing system is further configured to determine a variation in fore-aft deflection of the portion of the length of the wing frame section based at least in part on the data generated by the sensor,
wherein the computing system is configured to control the operation associated with the agricultural applicator based at least in part on the variation in the fore-aft deflection and the variation in the pitch of the wing frame section.

8. The agricultural system of claim 1, wherein computing system is configured to control the operation associated with the agricultural applicator by at least one of automatically adjusting at least one of a ground speed of the agricultural applicator, controlling an operation of a user interface to indicate the variation in the pitch of the wing frame section, controlling an actuator of the wing frame section, or adjusting an operation of one or more of the plurality of nozzle assemblies.

9. The agricultural system of claim 1, wherein the sensor is positioned on the central frame section.

10. The agricultural system of claim 1, wherein the sensor comprises at least one of a camera or a LIDAR sensor.

11. An agricultural method for monitoring spray booms of an agricultural applicator, the agricultural applicator having a boom assembly comprising a central frame section and a wing frame section pivotably coupled to the central frame section, the wing frame section extending along a length defined between a first end and a second end, the agricultural applicator further having a plurality of nozzle assemblies spaced apart along the boom assembly, the agricultural method comprising:
receiving, with a computing system, data generated by a sensor having a field of view directed along a portion of the length of the wing frame section, the data being indicative of a pitch of the wing frame section along the portion of the length of the wing frame section;
determining, with the computing system, a variation in the pitch of the wing frame section along the portion of the length of the wing frame section based at least in part on the data; and
controlling, with the computing system, an operation associated with the agricultural applicator based at least in part on the variation in the pitch of the wing frame section.

12. The agricultural method of claim 11, wherein a first target is positioned on the wing frame section, the first target being within the field of view,
wherein determining the variation in the pitch of the wing frame section comprises determining the variation in the pitch of the wing frame section based at least in part on an orientation of the first target.

13. The agricultural method of claim 12, wherein a second target is spaced apart from the first target on the wing frame section along the portion of the length of the wing frame section, the second target being within the field of view,
wherein determining the variation in the pitch of the wing frame section comprises determining the variation in the pitch of the wing frame section based at least in part on a comparison of an orientation of the second target to the orientation of the first target.

14. The agricultural method of claim 13, wherein the wing frame section comprises a first wing frame section and a second wing frame section, the first wing frame section being pivotably coupled to the central frame section, the second wing frame section being pivotably coupled to the first wing frame section,
wherein the first target is on the first wing frame section and the second target is on the second wing frame section.

15. The agricultural method of claim 12, wherein the first target is asymmetric in at least one of color or shape.

16. The agricultural method of claim 11, wherein controlling the operation associated with the agricultural applicator comprises controlling the operation associated with the agricultural applicator when the variation in the pitch of the wing frame section is greater than a threshold variation.

17. The agricultural method of claim 11, further comprising determining, with the computing system, a variation in fore-aft deflection of the portion of the length of the wing frame section based at least in part on the data generated by the sensor,
wherein controlling the operation associated with the agricultural applicator comprises controlling the operation associated with the agricultural applicator based at least in part on the variation in the fore-aft deflection and the variation in the pitch of the wing frame section.

18. The agricultural method of claim 11, wherein controlling the operation associated with the agricultural applicator comprises at least one of automatically adjusting at least one of a ground speed of the agricultural applicator, controlling an operation of a user interface to indicate the variation in the pitch of the wing frame section, controlling an actuator of the wing frame section, or adjusting an operation of one or more of the plurality of nozzle assemblies.

19. The agricultural method of claim 11, wherein the sensor is positioned on the central frame section.

20. The agricultural method of claim 11, wherein the sensor comprises at least one of a camera or a LIDAR sensor.
